(19) United States
(12) Patent Application Publication
(10) Pub. No.: US 2015/0131018 A1
(43) Pub. Date: May 14, 2015

(54) LIQUID CRYSTAL DISPLAY DEVICE INCLUDING CONDUCTIVE SPACER

(71) Applicant: Samsung Display Co., Ltd., Yongin-si (KR)

(72) Inventors: Yeon-Mun JEON, Hwaseong-si (KR); Yi-Seop SHIM, Suwon-si (KR); Zhang-Soon JANG, Seoul (KR); Sung-Man KIM, Seoul (KR); Yu-Jin LEE, Asan-si (KR); Young-Je CHO, Asan-si (KR)

(21) Appl. No.: 14/293,386

(22) Filed: Jun. 2, 2014

(30) Foreign Application Priority Data
Nov. 14, 2013 (KR) 10-2013-0138277

(51) Int. Cl. G02F 1/1339

(52) U.S. Cl. CPC G02F 1/13394
USPC 349/42; 438/30

(57) ABSTRACT

A liquid crystal display device includes a first substrate, a thin film transistor on the first substrate, a first electrode on the first substrate and connected to the thin film transistor, a second substrate facing the first substrate, color filters on the first substrate or the second substrate, a black matrix between the color filters on the first substrate or the second substrate, a second electrode spaced apart from the first electrode and on the first substrate or the second substrate, a second electrode conductive line on the black matrix, a spacer which is between the first substrate and the second substrate and supports the first substrate and the second substrate, and a liquid crystal layer between the first substrate and the second substrate. The spacer is electrically connected to the second electrode and the second electrode conductive line.

This application claims priority to Korean Patent Application No. 10-2013-0138277, filed on Nov. 14, 2013, and all the benefits accruing therefrom under 35 U.S.C. §119, the content of which is incorporated herein in its entirety by reference.

### BACKGROUND

1. Field

Exemplary embodiments of the invention relate to a liquid crystal display device provided with a conductive spacer that leads to improvement in aperture ratio.

2. Description of the Related Art

A liquid crystal display (“LCD”) device is drawing attention as a flat panel display device because the LCD device can be manufactured in the form of a relatively thin flat panel, and has advantages of good portability and low power consumption.

In general, the LCD device is driven by using the properties of optical anisotropy and polarization of a liquid crystal. The liquid crystal has a relatively long and thin shape, shows a director of molecular arrangement, and an orientation of the molecular arrangement thereof may be controlled by forcibly applying an electric field. As described above, the molecular arrangement of the liquid crystal may be adjusted so that an amount of light passing through the liquid crystal may also be adjusted, and accordingly image information may be represented.

The LCD device may be categorized into a vertical alignment (“VA”) mode and an in-plane switching (“IPS”) mode according to methods for forming an electric field.

In a general VA mode LCD device, a first electrode is disposed on a first substrate otherwise referred to as a thin film transistor (“TFT”) array substrate, a second electrode is disposed on a second substrate otherwise referred to as a color filter substrate, and a liquid crystal is interposed between the two substrates, and the liquid crystal is driven by an electric field applied between the first electrode and the second electrode. The VA mode LCD device shows excellent characteristics of contrast ratio, transmission and aperture ratio.

In an IPS mode LCD device, a first electrode and a second electrode are each disposed on one single substrate, namely on a first substrate otherwise referred to as a TFT array substrate in order to improve an viewing angle. The IPS mode LCD device exhibits a superior viewing angle. However, since the second electrode is also disposed on the first substrate, a conductive line for the second electrode configured to supply a common voltage to the second electrode and a contact hole configured to bring the conductive line for the second electrode into contact with the second electrode are also disposed on the first substrate, reducing a size of a pixel area of the LCD device. Since the size of the pixel area is reduced, an aperture ratio is undesirably lowered due to reduction in the size of the pixel area.

### SUMMARY

One or more exemplary embodiment of the invention is directed toward a liquid crystal display device having an improved aperture ratio.

Further, one or more exemplary embodiment of the invention is directed toward a liquid crystal display device including a conductive spacer.

According to an exemplary embodiment of the invention, a liquid crystal display device includes a first substrate, a thin film transistor on the first substrate, a first electrode on the first substrate and connected to the thin film transistor, a second substrate facing the first substrate, color filters on the first substrate or the second substrate, a black matrix on the first substrate or the second substrate to be disposed between the color filters, a second electrode on the first substrate or the second substrate to be spaced apart from the first electrode, a second electrode conductive line on the black matrix, a spacer interposed between the first substrate and the second substrate to support the first substrate and the second substrate, and a liquid crystal layer between the first substrate and the second substrate. The spacer is electrically connected to the second electrode and the second electrode conductive line.

The spacer may include a conductive polymer.

The conductive polymer may include at least one selected from polyacetylene, polythiophene, poly(3-alkyl thiophene), polypyrrole, poly(isothianaphthene), poly(ethylenedioxythiophene), alkoxy-substituted poly(para-phenylene vinylene), poly(para-phenylene vinylene), poly(2,5-dialkoxy-para-phenylene vinylene), poly(para-phenylene), ladder-type poly(para-phenylene), poly(para-phenylene sulphide), polyheptadiyne, poly(3-hexylthiophene) and polyaniline.

The spacer may include a polymer resin, and a conductive filler dispersed in the polymer resin.

The polymer resin may include at least one selected from conductive polymer and photo-polymerized polymer.

The conductive filler may include at least one selected from a metal particle, a metal particle coated with a metal, a non-metal particle coated with a metal, a conductive non-metal particle, a metal particle coated with conductive non-metal, and conductive polymer.

The spacer may have a compression stability of about 70% or more.

The spacer may have a sheet resistance of about 150 ohms per square (Ω/sq) or less.

The first substrate may include a display area where an image is displayed, and a non-display area where an image is not displayed. A common voltage supply line may be in the non-display area of the first substrate, and the common voltage supply line may be electrically connected to the second electrode conductive line via the spacer.

The second electrode may be on the first substrate and spaced apart from the first electrode.

The first electrode may overlap the second electrode in an area corresponding to the color filters, and an insulating layer may be between the overlapping first and second electrodes in the area corresponding to the color filters.

The first electrode or the second electrode may include a plurality of branch electrodes.

The black matrix may be on the second substrate.

According to an embodiment of the invention, a method of manufacturing a liquid crystal display device includes forming a thin film transistor and a first electrode connected to the thin film transistor on a first substrate, forming color filters on the first substrate or a second substrate, forming a black matrix on the first substrate or the second substrate and between the color filters, forming a second electrode on the first substrate or the second substrate and spaced apart from the first electrode, forming a second electrode conductive line on the black matrix, forming a spacer on the first substrate or the second substrate, providing a liquid crystal layer between the first substrate and the second substrate, and coupling the first substrate and the second substrate to each other with the spacer interposed therebetween. The forming the spacer includes coating a spacer-forming polymer composition on the first substrate and the second substrate, to form a polymer resin, and patterning the polymer resin formed by the polymer composition. In the coupling the first substrate and the second substrate to each other, the spacer is electrically connected to the second electrode and the second electrode conductive line.

The polymer composition may include photo-polymerizable initiator, photo-polymerizable monomer, photo-polymerizable oligomer, and conductive filler.

According to one or more exemplary embodiment of the invention, the liquid crystal display device includes the spacer configured to electrically connect the second electrode and the second electrode conductive line so as to reduce loss of a pixel area, and thus an aperture ratio may be improved. Further, according to one or more exemplary embodiment of the invention, the spacer including a conductive polymer resin serves as both a conductive wire and cushioning, and also serves to maintain a cell gap between the first substrate and the second substrate.

The foregoing summary is illustrative only and is not intended to be in any way limiting. In addition to the illustrative advantages exemplary embodiments, and features described above, further advantages, exemplary embodiments, and features will become apparent by reference to the drawings and the following detailed description.

### BRIEF DESCRIPTION OF THE DRAWINGS

The above and other features of the invention will be more clearly understood from the following detailed description taken in conjunction with the accompanying drawings, in which:

FIG. 1 is a plan view showing an exemplary embodiment of a liquid crystal display device;

FIG. 2 is a cross-sectional view taken along line I-I′ of FIG. 1;

FIG. 3 is a schematic circuit diagram of an exemplary embodiment of a pixel portion of the liquid crystal display device shown in FIG. 1;

FIG. 4 is a plan view showing an exemplary embodiment of a liquid crystal display device according to the invention;

FIG. 5 is a cross-sectional view taken along line II-II′ of FIG. 4 and showing a non-display area extending from line II-II′ of FIG. 4;

FIG. 6 is a schematic circuit diagram of an exemplary embodiment of a pixel portion of the liquid crystal display device shown in FIG. 4;

FIG. 7 is a diagram showing a comparison between openings of the liquid crystal display devices A and B shown in FIGS. 1 and 4, respectively;

FIG. 8 is a plan view showing another exemplary embodiment of a liquid crystal display device according to the invention;

FIG. 9 is a cross-sectional view taken along line II-II′ of FIG. 8 and showing a non-display area extending from line II-II′ of FIG. 8; and

FIGS. 10A to 10H are schematic diagrams showing an exemplary embodiment of a manufacturing process of a liquid crystal display device according to the invention.

### DETAILED DESCRIPTION

Hereinafter, exemplary embodiments of the invention will now be described in detail with reference to the accompanying drawings. The invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art.

In the drawings, certain elements or shapes may be simplified or exaggerated to better illustrate the invention, and other elements present in an actual product may also be omitted. Thus, the drawings are intended to facilitate the understanding of the invention. Like reference numerals refer to like elements throughout the specification.

In addition, when a layer or element is referred to as being “on” another layer or element, the layer or element may be directly on the other layer or element, or one or more intervening layers or elements may be interposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

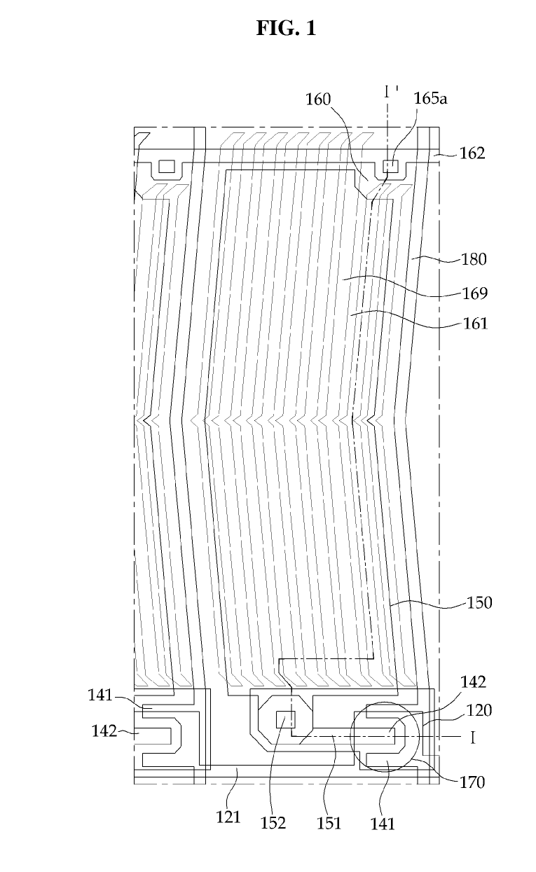

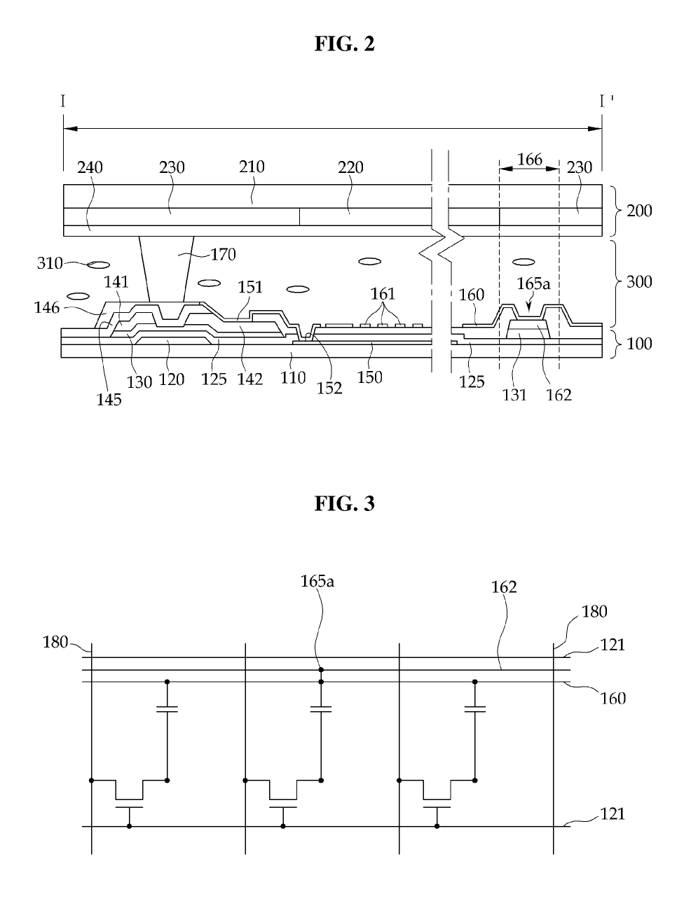

FIG. 1 is a plan view showing an exemplary embodiment of a liquid crystal display (“LCD”) device, namely an in-plane switching mode LCD. FIG. 2 is a cross-sectional view taken along line I-I′ of FIG. 1.

As illustrated in FIGS. 1 and 2, a conventional LCD includes a first substrate 110 and a second substrate 210 that face each other, and a liquid crystal layer 300 interposed therebetween.

A lower plate 100 including the first substrate 110 will be first described below.

A gate line 121, a gate electrode 120 and a first electrode 150 are disposed on the first substrate 110 including transparent glass or plastic.

The gate line 121 and the gate electrode 120 may include an aluminum-based metal such as aluminum (Al) or aluminum alloy, a silver-based metal such as silver (Ag) or silver alloy, a copper-based metal such as copper (Cu) or copper alloy, a molybdenum-based metal such as molybdenum (Mo) or molybdenum alloy, chromium (Cr), tantalum (Ta), titanium (Ti), or the like. The gate line 121 and the gate electrode 120 may have a multilayer structure in a cross-sectional thickness direction in which two or more conductive layers having different physical or chemical properties are laminated.

The first electrode 150 may include transparent conductive materials, e.g., indium tin oxide (“ITO”), indium zinc oxide (“IZO”), and aluminum doped zinc oxide (“AZO”), which are polycrystalline, single crystal (monocrystalline) or non-crystalline (amorphous). In FIG. 1, the first electrode 150 is disposed as a surface electrode, and has a pair of bent portions in the plan view such as a top plan view. The first electrode 150 acts as a pixel electrode in the LCD device shown in FIGS. 1 and 2.

A gate insulating layer 125 including silicon nitride (SiNx), silicon oxide (SiOx), or the like is disposed on the gate line 121, the gate electrode 120 and the first electrode 150. The gate insulating layer 125 may have a multilayer structure in a cross-sectional thickness direction in which two or more insulating layers having different physical or chemical properties are included.

A semiconductor layer 130 including a semiconductor-forming material is disposed on the gate insulating layer 125. The semiconductor layer 130 may include amorphous silicon or polycrystalline silicon, or may include oxide. The semiconductor layer 130 may overlap at least a portion of the gate electrode 120.

A wire pattern 131 including the semiconductor-forming material may be disposed in a position where a second electrode conductive line 162 will also be disposed. The semiconductor layer 130 and the wire pattern 131 may be disposed in a same layer such as in a same single layer of the lower plate 100.

Although not illustrated, a resistive contact member may be disposed on the semiconductor layer 130. The resistive contact member may include a material such as hydrogenated amorphous silicon doped with phosphorus, or silicide.

A data line 180, a source electrode 141, and a drain electrode 142, which of which include an electrical conductor, are disposed on the semiconductor layer 130 and the gate insulating layer 125. Further, the second electrode conductive line 162, which includes the electrical conductor, is disposed on the line pattern 131. The data line 180, the source electrode 141, the drain electrode 142 and the second electrode conductive line 162 may be in a same layer such as in a same single layer of the lower plate 100.

The data line 180, the source electrode 141 and the drain electrode 142 may include the same electrical conductor as or of a different electrical conductor from the gate line 121, the gate electrode 120 and the first electrode 150.

In detail, the data line 180, the source electrode 141 and the drain electrode 142 may include refractory metals such as molybdenum (Mo), chromium (Cr), tantalum (Ta), and titanium (Ti) or alloys thereof, or may have a multilayer structure in a cross-sectional thickness direction and including a refractory metal layer and a low resistance conductive layer. The multilayer structure may include, for example, a double layer containing a bottom layer including chromium or molybdenum (an alloy thereof) and a top layer including aluminum (an alloy thereof), and a triple layer containing a bottom layer including molybdenum (an alloy thereof), a middle layer including aluminum (an alloy thereof) and a top layer including molybdenum (an alloy thereof).

The data line 180, the source electrode 141 and the drain electrode 142 may include many different metals or electrical conductors besides the above-described materials.

The data line 180 may include a terminal part (not shown) for connection to a different layer or an external drive circuit. The data line 180 transmits a data signal, and mostly extends in a longitudinal direction to intersect the gate line 121 and the second electrode conductive line 162. The data line 180 may include a bent portion in order to improve a transmittance of the LCD device, and referring to FIG. 1, the data line 180 may be bent in a V-shape in substantially the middle of a pixel area in the longitudinal (e.g., vertical) direction.

In an exemplary embodiment, the pixel area of an LCD device may be defined by the data line 180 and the gate line 120. However, the invention is not limited thereto, and the pixel area also be defined by a black matrix disposed on the first substrate 110 or the second substrate 210. To maximize an aperture ratio of the pixel area, a display portion of the pixel area should be maximized.

The source electrode 141 extends from the data line 180 and is disposed on the semiconductor layer 130. The drain electrode 142 is spaced apart from the source electrode 141 and is disposed on the semiconductor layer 130.

A thin film transistor (“TFT”) includes the gate electrode 120, the source electrode 141, the drain electrode 142 and the semiconductor layer 130. A channel of the TFT is defined by a portion of the semiconductor layer 130 exposed between the source electrode 141 and the drain electrode 142.

The second electrode conductive line 162 transmits common voltage to a second electrode 160, and includes an extension portion for connection to the second electrode 160. A second electrode contact part 165a configured to connect the second electrode 160 and the second electrode conductive line 162 is located at the extension portion. The second electrode conductive line 162 may be disposed parallel to the gate line 121, and may include the same material as the gate line 121.

A passivation layer 145 is disposed on the data line 180, the source electrode 141, the drain electrode 142 and the exposed portion of the semiconductor layer 130. The passivation layer 145 is also disposed on the gate insulating layer 125 disposed on the first electrode 150.

The passivation layer 145 may include an inorganic insulation material such as silicon nitride and silicon oxide, or may also include an organic insulation material. Further, the passivation layer 145 may have a multilayer structure in a cross-sectional thickness direction and include inorganic and organic layers in order to exhibit excellent insulating properties and protect the exposed portion of the semiconductor layer 130. The passivation layer 145 may have a thickness of about 5000 angstroms (A) or more, or may have a thickness of about 6000 Å to about 8000 Å.

Contact holes are defined in the passivation layer 145 to expose the drain electrode 142 and the first electrode 150, respectively, such that the drain electrode 142 and the first electrode 150 are electrically connected therethrough. In an exemplary embodiment of manufacturing a LCD device, a contact hole may be further defined by removing portions of both the gate insulating layer 125 and the passivation layer 145 to expose the first electrode 150.

A first electrode connection part 151 configured to connect the drain electrode 142 and the first electrode 150 exposed as described above, is disposed for the physical and electrical connection between the drain electrode 142 and the first electrode 150.

Further, in an exemplary embodiment of manufacturing a LCD device, the passivation layer 145 on the second electrode conductive line 162 for is partly removed so that the second electrode conductive line 162 may be exposed for connection with the second electrode contact part 165a. An area corresponding to the second electrode contact part 165a may be a second electrode contact region 166 in which the second electrode 160 contacts the second electrode conductive line 162.

The second electrode 160 is disposed on the passivation layer 145. The second electrode contact part 165a may be a portion of the second electrode 160 which contacts the second electrode conductive line 162. The second electrode 160 is connected to the second electrode conductive line 162 by the second electrode contact part 165a, and therefore common voltage may be applied to the second electrode 160 from the second electrode conductive line 162. The second electrode 160 includes a plurality of cutout portions 169 which define a plurality of branch electrodes 160. An area of the second electrode 160 overlaps the first electrode 150. In detail, the plurality of branch electrodes 161 is disposed in the overlapping area of the first and second electrodes 150 and 160. The second electrode 160 acts as a common electrode in the LCD device illustrated in FIGS. 1 and 2.

The second electrode 160 may include transparent conductive materials, e.g., ITO, IZO, and AZO, which are polycrystalline, monocrystalline or amorphous. Second electrodes 160 disposed in adjacent pixels of the LCD device are connected to each other.

In an exemplary embodiment of manufacturing a LCD device, in order to form the second electrode 160, a second electrode-forming material is coated on an upper portion of the passivation layer 145 and at a location of the second electrode contact part 165a. Thereafter the second electrode-forming material is partially removed from the area overlapping the first electrode 150, so that the plurality of cutout portions 169 are formed, and as a result the plurality of branch electrodes 161 are formed. The partially removing the second electrode-forming material may also define the second electrode contact part 165a.

In an exemplary embodiment of manufacturing a LCD device, the branch electrodes 161 and the first electrode connection part 151 may be simultaneously formed. The second electrode 160 including the plurality of branch electrodes 161, and the first electrode connection part 151, may be in a same layer such as in a same single layer.

Next, an upper plate 200 including the second substrate 210 will be described below.

A color filter 220 and a black matrix 230 are disposed on the second substrate 210 including transparent glass or plastic.

In detail, a plurality of color filters 220 may be disposed on the second substrate 210, and may be divided from each other by the black matrix 230. Each color filter 220 may display one of red, green and blue, or may display a different color.

The black matrix 230 divides the plurality of color filters 220 from each other, defines a pixel area of a pixel of the LCD device, and reduces or effectively prevents leakage of light.

An insulating layer 240 is disposed on the color filter 220 and the black matrix 230. The insulating layer 240 may include an inorganic or organic insulation material, reduced or effectively prevent the color filter 220 from being exposed, and provide a flat surface of the upper plate 200. In an alternative exemplary embodiment, the insulating layer 240 may be omitted.

A spacer 170 is disposed between the first substrate 110 and the second substrate 220, is configured to support the first substrate 110 and the second substrate 220, and to secure a gap between the upper and lower plates 100 and 200. The spacer 170 may not be disposed at an opening area but at a black matrix (e.g., non-opening) area including the black matrix 230. As illustrated in FIGS. 1 and 2, the spacer 170 may be disposed on the TFT. A planarization layer 146 may be disposed on the TFT for stable arrangement of the spacer 170.

A liquid crystal 310 is interposed in the gap secured by the spacer 170 so that the liquid crystal layer 300 may be defined. A long axis of the liquid crystal 310 may be arranged substantially parallel to the first substrate 110. Further, the long axis of the liquid crystal 310 may be arranged to be spirally twisted at about 90 degrees taken from a direction of the branch electrode 161 on the first substrate 110, to the second substrate 210.

When data voltage is applied to the first electrode 150, and common voltage is applied to the second electrode 160, an electric field is generated between the first electrode 150 and the second electrode 160, and the liquid crystal 310 existing in the liquid crystal layer 300 rotates and is oriented due to the electric field. Polarization of light passing through the liquid crystal layer 300 varies depending on a rotating direction of the liquid crystal 310.

With respect to the LCD device illustrated in FIG. 1, where no electric field is applied, the liquid crystal 310 of the liquid crystal layer 300 is aligned with a predetermined pretilt angle by an alignment layer (not shown). On the other hand, where an electric field is applied, the liquid crystal 310 may rotate in a pretilt direction in response to the electric field.

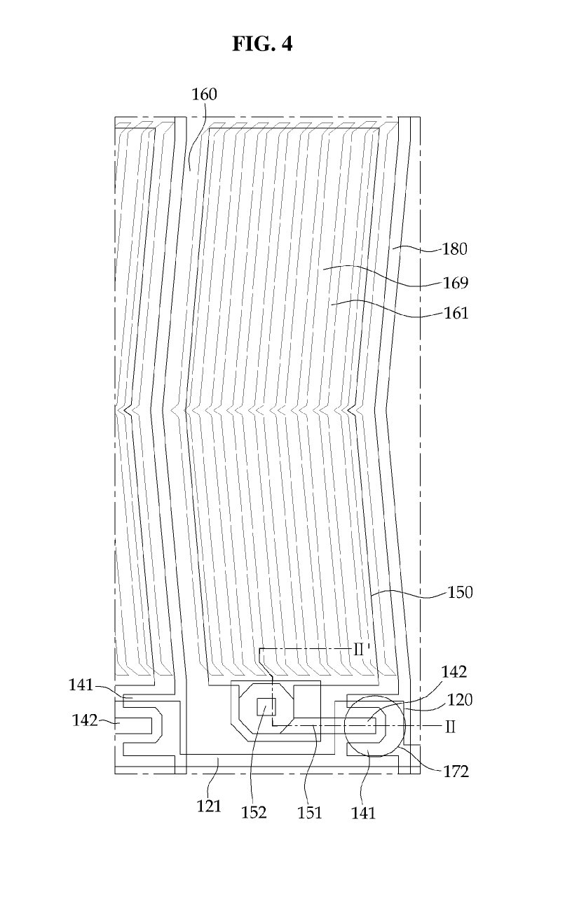

FIG. 3 is a schematic circuit diagram of an exemplary embodiment of a pixel portion of the LCD device shown in FIG. 1. Herein, the gate line 121 and the second electrode conductive line 162 are disposed on the first substrate 110 of the lower plate 100.

In the in-plane switching (“IPS”) mode LCD device of FIG. 1, the second electrode conductive line 162 is provided to apply predetermined common voltage to the second electrode 160. The second electrode conductive line 162 is disposed on the first substrate 110 along a pixel array extending in a traverse direction (e.g., horizontal in FIGS. 1 and 3) crossing the longitudinal direction so as to reduce or effectively prevent voltage drop of the second electrode 160 in a display area of the pixel of the LCD device. The second electrode contact part 165a configured to connect the second electrode conductive line 162 and the second electrode 160 is provided at the second electrode contact region 166 of the first substrate 110. However, an area occupied by the second electrode conductive line 162 and the second electrode contact part 165a does not serve as a display portion of the pixel area of the LCD device. As noted above, to maximize an aperture ratio of the pixel area, a display portion of the pixel area should be maximized. Since the second electrode contact part 165a does not serve as a display portion of the pixel area, an aperture ratio of the LCD device is lowered by as much as the area occupied by the second electrode conductive line 162 and the second electrode contact part 165a.

The second electrode conductive line 162 and the second electrode contact part 165a are conductive lines configured to supply electric power, and thus planar areas thereof remain relatively constant. In a low-resolution LCD device, the second electrode conductive line 162 and the second electrode contact part 165a may occupy a relatively low percentage of the total display area because each pixel of the LCD device has a relatively large size. Therefore, decrease of an aperture ratio by the second electrode conductive line 162 and the second electrode contact part 165a may not be deemed considerable. On the other hand, in a high-resolution LCD device, the second electrode conductive line 162 and the second electrode contact part 165a may occupy a relatively high percentage of the total display area because each pixel of the LCD device has a relatively small size. Therefore, the decrease of an aperture ratio of the LCD device may be deemed relatively huge.

One or more exemplary embodiment according to the invention provides an LCD device including a conductive spacer serving as a conductive wire in order to reduced or effectively prevent an aperture ratio from being reduced. According to one or more exemplary embodiment of the invention, although the second electrode conductive line 162 is not disposed on the first substrate 110, common voltage may be applied to the second electrode 160 on the first substrate 110. Consequently, the pixel area of the first substrate 110 may not be lowered, and the LCD device may have an improved aperture ratio.

According to one or more exemplary embodiment of the invention, the conductive spacer may include a polymer resin having predetermined stiffness and conductivity so as to act as a cushion by being interposed between the first substrate 110 and the second substrate 210.

In detail, according to one or more exemplary embodiment of the invention, an LCD device includes a first substrate 110, a TFT on the first substrate 110, a first electrode 150 on the first substrate 110 and connected to the TFT, a second substrate 210 facing the first substrate 110, a color filter 220 on any one of the first substrate 110 and the second substrate 210, a black matrix 230 on the first substrate 110 and/or the second substrate 210 to be disposed between the color filters 220, a second electrode 160 on the first substrate 110 and/or the second substrate 210 to be spaced apart from the first electrode 150, a second electrode conductive line 163 on the black matrix 230, a spacer 172 interposed between the first substrate 110 and the second substrate 210 to support the first substrate 110 and the second substrate 210, and a liquid crystal layer 300 between the first substrate 110 and the second substrate 210. The spacer 172 is electrically connected to the second electrode 160 and the second electrode conductive line 163.

The TFT includes a gate electrode 120, a source electrode 141, a drain electrode 142 and a semiconductor layer 130.

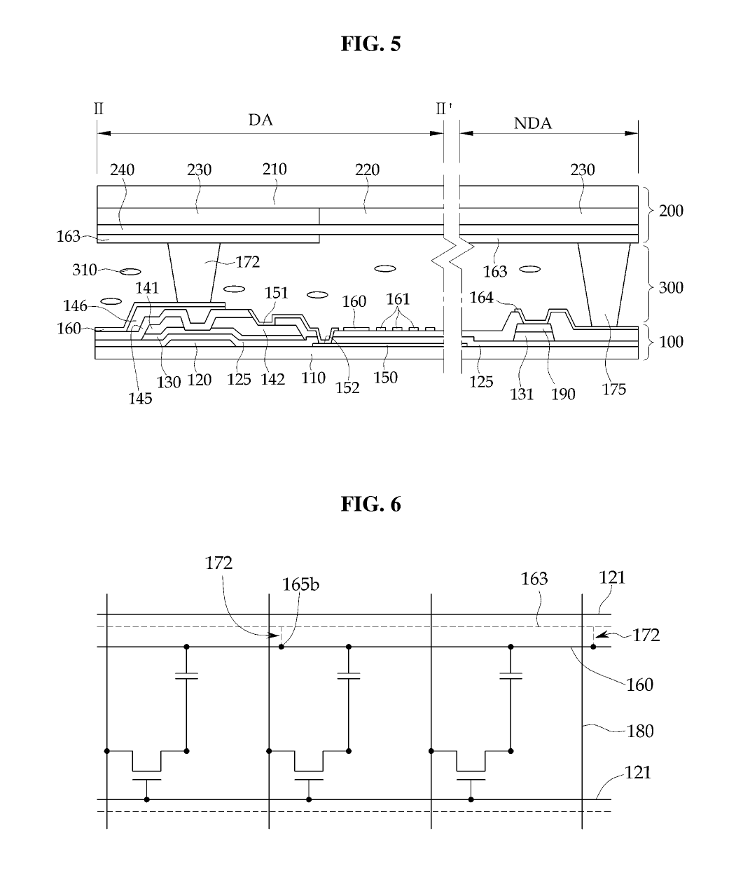

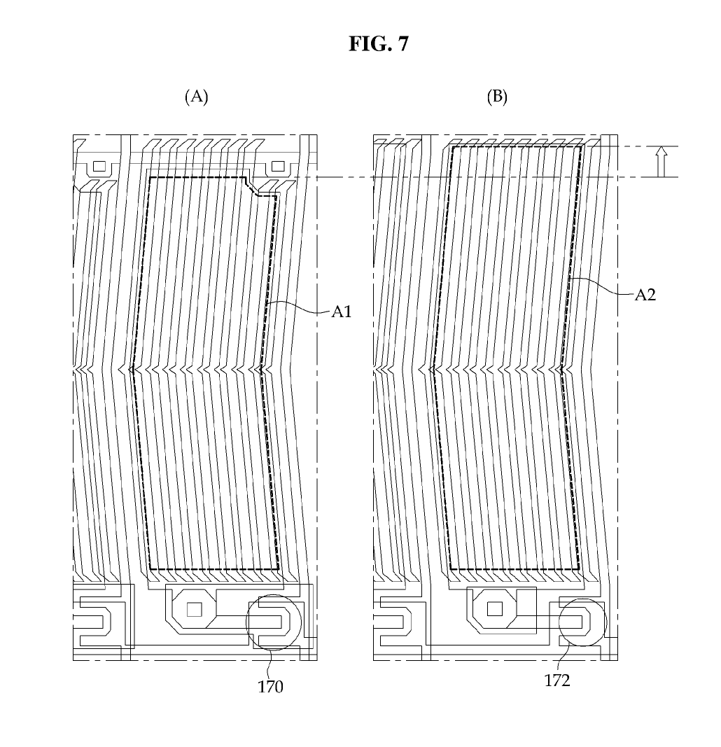

FIGS. 4 and 5 illustrates an exemplary of a LCD device according to the invention. Herein, a lower plate 100 includes the first substrate 110, the TFT, the first electrode 150 and the second electrode 160, and an upper plate 200 includes the second substrate 210, the color filter 220, the black matrix 230 and the second electrode conductive line 163.

FIG. 5 illustrates an IPS mode LCD device in which the first and second electrodes 150 and 160 are disposed on the first substrate 110. In an LCD device in which an electric field is applied in a direction perpendicular to a substrate as in vertical alignment (“VA”) and twisted nematic (“TN”) modes, the second electrode 160 may be disposed on the second substrate 210.

Referring to FIG. 5, the black matrix 230 and the color filter 220 are each disposed on the second substrate 210, but the black matrix 230 may be disposed on the first substrate 110. Similarly, the color filter 220 may also be disposed on the first substrate 110. In an exemplary embodiment, for example, in a color filter on array (“COA”) in which the color filter 220 is disposed on a TFT array substrate, the color filter 220 may be disposed on the first substrate 110 where the TFT is disposed. Further, in a black matrix on array (“BOA”) in which the color filter 220 and the black matrix 230 are each disposed on the TFT array substrate, the black matrix 230 and the color filter 220 may be disposed on the first substrate 110 on which the TFT is formed.

In FIG. 5, the first electrode 150 and the second electrode 160 overlap each other, with a gate insulating layer 125 and a passivation layer 145 interposed therebetween, in an area corresponding to the color filter 220. The gate insulating layer 125 and the passivation layer 145 may be insulating layers.

In FIGS. 4 and 5, the first electrode 150 acts as a pixel electrode, and the second electrode 160 acts as a common electrode.

The first electrode 150 and/or the second electrode 160 may have a plurality of branch electrodes defined therein. Referring to FIGS. 4 and 5, the second electrode 160 includes the plurality of branch electrodes 161 defined therein. However, the first electrode 150 may have the plurality of branch electrodes defined therein, or both of the first electrode 150 and the second electrode 160 may have the plurality of branch electrodes defined therein.

Further, any one of the first electrode 150 and the second electrode 160 may be a surface electrode (e.g., planar or plate-shaped) and the other of the first electrode 150 and the second electrode 160 may include a plurality of branch electrodes 161 defined therein. Referring to FIGS. 4 and 5, the first electrode 150 is a surface electrode, and the second electrode 160 includes a plurality of branch electrodes 161 therein. However, the second electrode 160 may be a surface electrode, and the first electrode 150 may have a plurality of branch electrodes defined therein.

The first substrate 110 includes a display area DA in which an image is displayed and a non-display area NDA in which no image is displayed. The non-display area NDA corresponds to an edge portion of the first substrate 110 where no pixel is disposed. A common voltage supply line 190 configured to supply common voltage to the second electrode 160 is disposed at the non-display area NDA of the first substrate 110. As described above, the common voltage supply line 190 is disposed at the edge portion of the first substrate 110 where no pixel is disposed, so that reduction or loss of a pixel area is reduced or effectively prevented.

The common voltage supply line 190 may be electrically connected to the second electrode conductive line 163 of the upper plate 200, which is disposed on the second substrate 210, by a conductive spacer 175 of the non-display area NDA and a line 164 for the second electrode of the lower plate 100.

In detail, FIG. 5 is a cross-sectional view showing a display area DA taken along line II-II′ of FIG. 4 and showing a non-display area NDA extending from line II-II′ of FIG. 4. Such non-display area NDA extending from line II-II′ of FIG. 4 may be considered outside a pixel area of the LCD device.

As illustrated in FIG. 5, the common voltage supply line 190 is disposed at the non-display area NDA of the first substrate 110, and is connected to the line 164 for the second electrode of the lower plate 100, which is disposed at the non-display area NDA. The lower plate second electrode line 164 is connected to the spacer 175 of the non-display area NDA, and the spacer 175 of the non-display area NDA is electrically connected to the upper plate second electrode conductive line 163 on the black matrix 230. Further, the upper plate second electrode conductive line 163 on the black matrix 230 is connected to the spacer 172 on the TFT, and the spacer 172 on the TFT is connected to the second electrode 160. Therefore, the common voltage supply line 190 may supply common voltage to the second electrode 160 because of such connections. The upper plate second electrode conductive line 163 may be in both the display area DA and the non-display area NDA. The lower plate second electrode line 164 may be in only the non-display area NDA, but the invention is not limited thereto.

When common voltage is applied to the common voltage supply line 190, the spacer 175 of the non-display area NDA is applied with the common voltage via the lower plate second electrode line 164, and the spacer 172 of the display area DA is applied with the common voltage via the upper plate second electrode conductive line 163. As a result, the common voltage is applied to the second electrode 160 electrically connected to the spacer 172 of the display area DA.

The conductive spacer 172 of the display area DA has a cross-sectional thickness, namely a height, that may vary depending on the size and thickness of an LCD device. The spacer 172 may have a cross-sectional thickness of about 2 micrometers (μm) to about 5 μm. The thickness of the spacer 172 may also increase according to the size and thickness of an LCD device. The spacer 172 may be disposed in each pixel area, but one spacer 172 may be disposed for about three to five pixel areas or for about ten to twenty pixel areas.

Further, the spacer 172 may maintain a cell gap between the first substrate 110 and the second substrate 210. To this end, the spacer 172 may have a compression stability of about 70% or more, when e.g. pressure of 5 grams-force (gf) is applied to the spacer 172.

The spacer 172 may be configured to have conductivity to apply common voltage to the second electrode 160. The resistance of the spacer 172 may be relatively small for smooth application of the common voltage. Where the second electrode 160 is a transparent electrode, the spacer 172 may have the same conductivity as the second electrode 160. Therefore, the spacer 172 may have a surface resistance of 150 ohms per square (Ω/sq) or less, and for example a surface resistance of 40 Ω/sq to 150 Ω/sq.

The spacer 172 includes conductive polymer resin. The conductive polymer resin includes at least one selected from polymer resins in which conductive polymer and conductive filler are dispersed.

In other words, the spacer 172 may include a conductive polymer. The conductive polymer may include at least one selected from polyacetylene, polythiophene, poly(3-alkyl thiophene), polypyrrole, poly(isothianaphthene), poly(ethylenedioxythiophene), alkoxy-substituted poly(para-phenylene vinylene), poly(para-phenylene vinylene), poly(2,5-dialkoxy-para-phenylene vinylene), poly(para-phenylene), ladder-type poly(para-phenylene), poly(para-phenylene sulphide), polyheptadiyne, poly(3-hexylthiophene), and polyaniline.

Further, the spacer 172 may include a polymer resin, and a conductive filler dispersed in the polymer resin. The spacer 172 may have a relatively high conductivity and compression stability, by including the polymer resin and the conductive filler.

The polymer resin may include at least one of conductive polymer and photo-polymerized polymer. The conductive polymer is a polymer that itself conducts electricity and is exemplified above. The photo-polymerized polymer is a polymer polymerized and cured by light irradiation, and has predetermined stiffness and compression stability.

The photo-polymerized polymer may include at least one selected from, for example, acrylic-based polymer, urethane polymer, epoxy-based polymer, polycarbonate, polyester and polyterephthalate (“PET”). The photo-polymerized polymer may also include at least one selected from, for example, polyester acrylate, urethane acrylate and epoxy acrylate.

The conductive filler may include at least one selected from, for example, a particle including metal, a metal particle coated with a metal, a non-metal particle coated with a metal, a particle including conductive non-metal, a metal particle coated with conductive non-metal and conductive polymer.

The spacer 172 may include a conductive filler in an amount of about 10 weight % to about 90 wt % of the total weight of the spacer.

The conductive filler may have a dimension such as a diameter of about 0.02 μm to about 2 μm. The metal may include at least one selected from gold (Au), silver (Ag), platinum (Pt), copper (Cu), nickel (Ni), tin (Sn), iron (Fe) and aluminum (Al). Further, the conductive non-metal may include at least one selected from carbon black, carbon fiber, and transparent conductive oxide (“TCO”). The TCO may include ITO, IZO, AZO or the like.

The non-metal particle coated with a metal may include at least one selected from gold coated graphite, gold coated glass, gold coated ceramic, gold coated plastic, gold coated mica, silver coated graphite, silver coated glass, silver coated ceramic, silver coated plastic, silver coated mica, nickel coated graphite, nickel coated glass, nickel coated ceramic, nickel coated plastic and nickel coated mica.

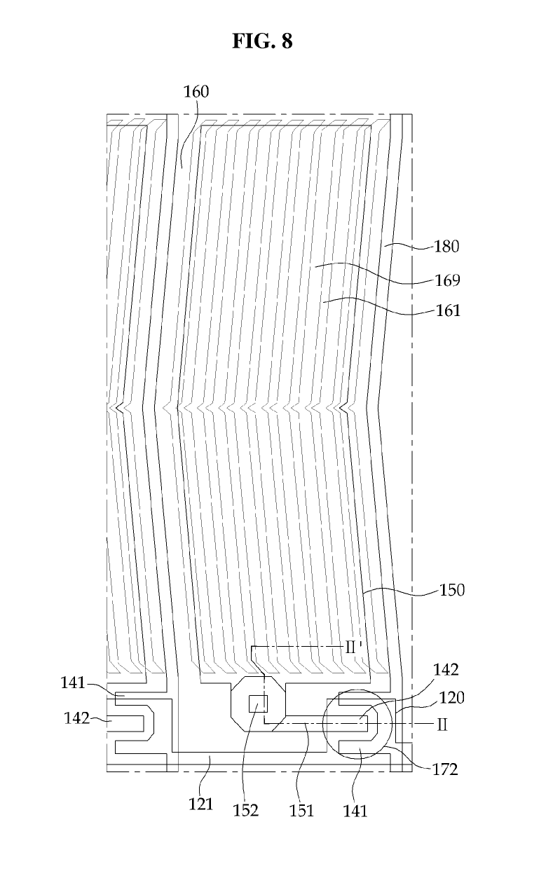

FIG. 6 is a schematic circuit diagram of the LCD device illustrated in FIG. 4. The horizontal dashed lines in the circuit diagram of FIG. 6 refers to the second electrode conductive line 163 on the second substrate 210. The vertical dashed lines in the circuit diagram of FIG. 6 refers to electrical connection between the upper plate second electrode conductive line 163 and the second electrode 160 by the spacer 172.

In the LCD device illustrated in FIGS. 4 and 5, the second electrode conductive line 163 is disposed in an area including the black matrix 230. In detail, the second electrode conductive line 163 is disposed in the non-display area NDA extending from line II-II′ of FIG. 4, which may be considered outside a pixel area of the LCD device. Since the second electrode conductive line 163 does not reduce a display portion of the pixel area, thus an opening area of the pixel area may be not reduced, thereby increasing an aperture ratio of the LCD device.

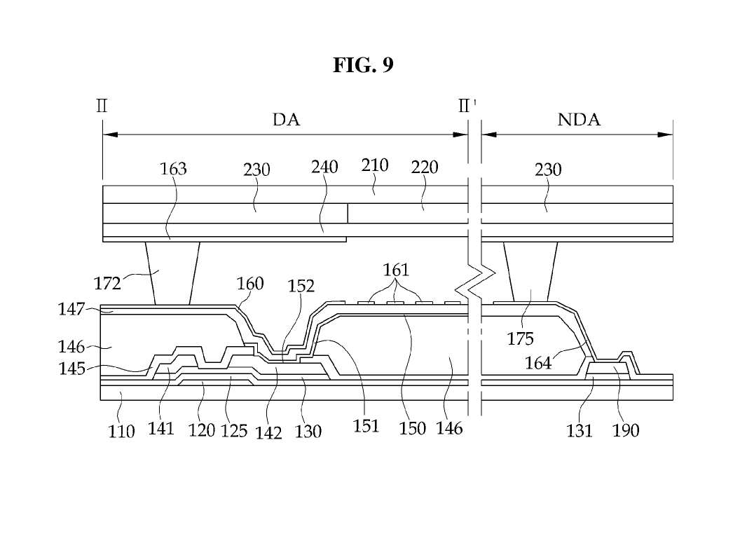

FIG. 7 is a diagram showing a comparison of pixel openings A1 and A2 of the LCD devices A and B respectively illustrated in FIGS. 1 and 4. A difference in areas of the pixel openings A1 and A2 is indicated by the arrow near an upper edge of the pixel openings A1 and A2.

For instance, opening A1 has an aperture ratio of about 61.76% and opening A2 has an aperture ratio of about 68.20% in a pixel portion of an LCD device having a size of 27 inches and a resolution of 120 pixels per inch (ppi). The difference of the aperture ratio is about 6.44%, and the aperture ratio of the LCD device illustrated in FIG. 4 is about 10.4% higher than that of the LCD device illustrated in FIG. 1.

As another example, opening A1 has an aperture ratio of about 48% and opening A2 has an aperture ratio of about 54% in a pixel portion of an LCD device having a size of 13.3 inches and a resolution of 230 ppi. In this example, the difference of the aperture ratio is about 6%, and the aperture ratio of opening A2 is about 12.5% higher than that of opening A1.

As described above, in a high-resolution LCD device, while each pixel has a relatively small size, an area occupied by the second electrode conductive line 162 and the second electrode contact part 165a has a relatively constant size, and thus a ratio of the area occupied by the second electrode conductive line 162 and the second electrode contact part 165a to each pixel area may increase, so that a relatively large loss of the aperture ratio may be caused. In this regard, one or more exemplary embodiment of an LCD device according to the invention may achieve an effect of improvement in the aperture ratio particularly of a high-resolution product.

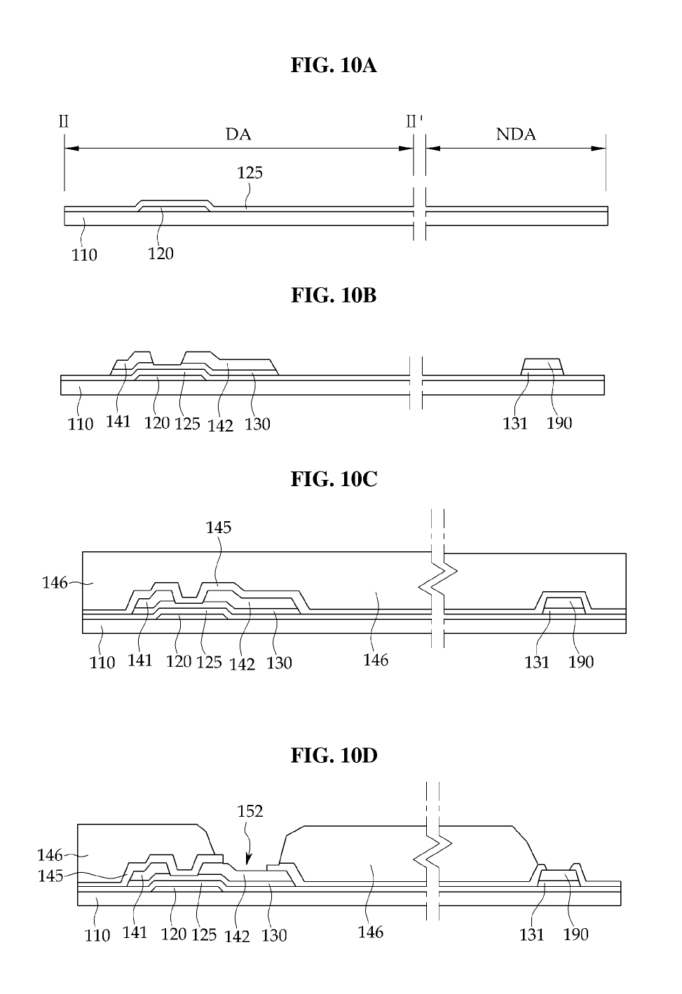

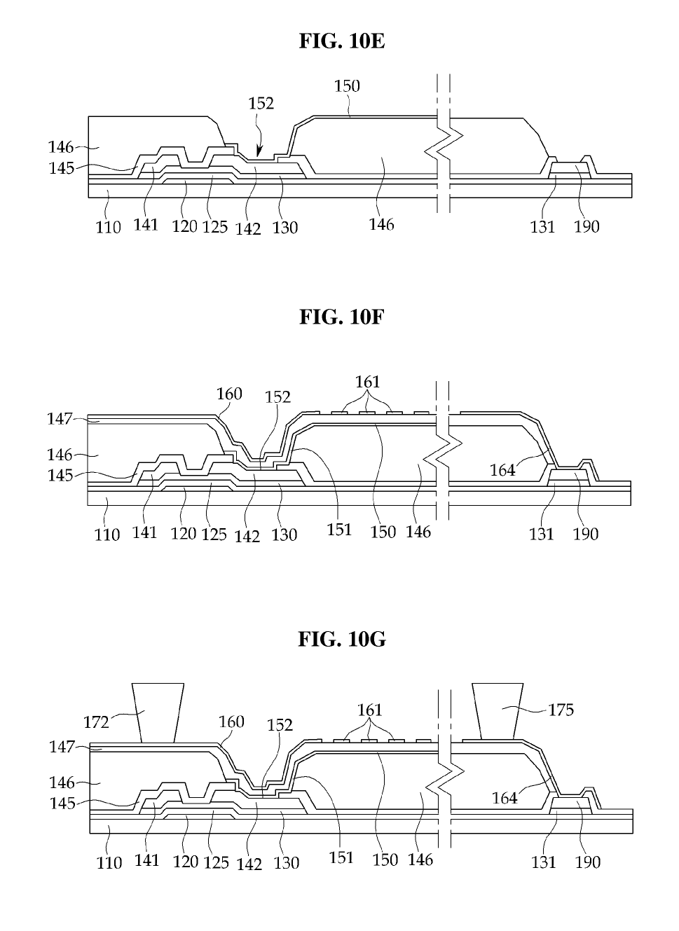

FIGS. 8 and 9 illustrate another exemplary embodiment of an LCD device according to the invention.

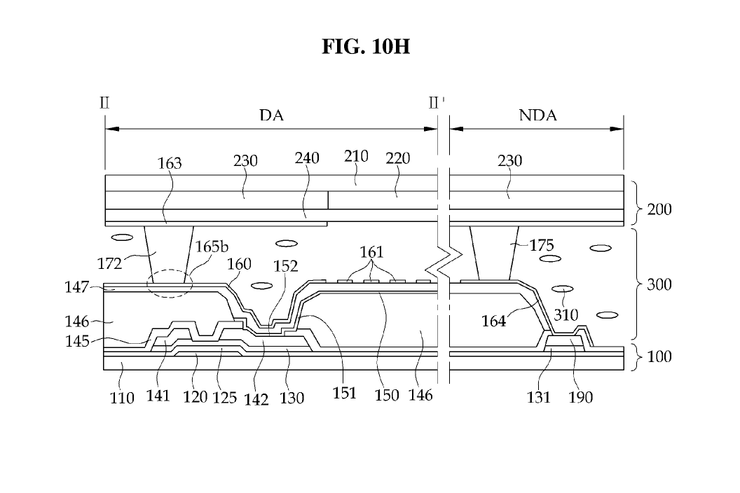

FIGS. 10A to 10H show an exemplary embodiment of a manufacturing process of an LCD device according to the invention.

Hereinafter, a configuration of the LCD device of FIGS. 8 and 9, and a manufacturing process of an LCD device according to the invention will be described with reference to FIGS. 10A to 10H.

According to an exemplary embodiment of the invention, a manufacturing process of an LCD device may include forming a lower plate 100, forming an upper plate 200, and bonding the lower plate 100 and the upper plate 200 to each other.

In order to manufacture the LCD device of FIGS. 8 and 9, the lower plate 100 may be fabricated by forming (e.g., providing) a TFT, a first electrode 150 connected to the TFT, and a second electrode 160 spaced apart from the first electrode 150, on a first substrate 110.

In detail, as illustrated in FIG. 10A, the gate electrode 120 may be formed on the first substrate 110 including transparent glass or plastic. The gate line 121 may be formed in conjunction with the gate electrode 120. The gate insulating layer 125 including silicon nitride (SiNx) or silicon oxide (SiOx) may be formed on the gate line 121 and the gate electrode 120.

The formation of the gate electrode 120, the gate line 121 and the gate insulating layer 125 is the same as that of FIGS. 4 and 5, and thus further description thereof will be omitted.

As illustrated in FIG. 10B, the semiconductor layer 130 may be formed on the gate insulating layer 125. The semiconductor layer 130 may include amorphous silicon, polycrystalline silicon or oxide. The semiconductor layer 130 overlaps at least a portion of the gate electrode 120.

The wire pattern 131 may be formed by using a semiconductor-forming material at the non-display area NDA that is an edge portion of the first substrate 110 where the common voltage supply line 190 configured to supply common voltage to the second electrode 160 may be formed. The semiconductor layer 130 and the wire pattern 131 may be in a same layer and/or may include the same material, e.g., the semiconductor-forming material.

The source electrode 141 and the drain electrode 142 may be formed on the semiconductor layer 130 by using an electrical conductor or electrical conducting material. The data line 180 may be formed on the gate insulating layer 125 (see FIG. 8). The common voltage supply line 190 may be formed by the electrical conductor on the wire pattern 131 formed at the non-display area NDA (see FIG. 10B). The data line 180, the source electrode 141, the drain electrode 142 and the common voltage supply line 190 may be in a same layer and/or may include the same material, e.g., the electrical conductor.

Although not illustrated, a resistive contact member may be disposed among the semiconductor layer 130, the source electrode 141 and the drain electrode 142.

The TFT may collectively include the gate electrode 120, the source electrode 141, the drain electrode 142 and the semiconductor layer 130. A portion of the semiconductor layer 130 is exposed between the source and drain electrodes 141 and 142, and may define a channel of the TFT.

A passivation layer 145 may be disposed on the source electrode 141, the drain electrode 142, the exposed portion of the semiconductor layer 130 the data line 180 and the common voltage supply line 190, and a planarization layer 146 may be disposed on the passivation layer 145 (see FIG. 100).

The planarization layer 146 and the passivation layer 145 are selectively removed so that a contact hole 152 exposing the drain electrode 142 and a contact hole exposing a top portion of the common voltage supply line 190 may be exposed (see FIG. 10D).

The first electrode 150 may extend from a top portion of the planarization layer 146 to the contact hole 152 of the drain electrode 142 (see FIG. 10E). The first electrode 150 may be electrically connected to the drain electrode 142 in the contact hole 152. In the illustrated exemplary embodiment, a surface electrode is exemplified as the first electrode 150. The first electrode connection part 151 and the first electrode 150 may be continuous with each other, may be in a same layer and/or may include the same material.

An insulating layer 147 may be formed at an area extending from an upper portion of the first electrode 150 to an upper part of the planarization layer 146 in the non-display area NDA. The second electrode 160 may be formed on the insulating layer 147, such that the insulating layer 147 is between overlapping portions of the first and second electrodes 150 and 160 in the display area DA. The lower plate second electrode line 164 may be formed at an exposure part of the common voltage supply line 190 disposed in the non-display area NDA that is an edge portion of the first substrate 110 (see FIG. 10F). The second electrode 160, the branch electrodes 161 and lower plate the second electrode line 164 may be in a same layer and/or include the same material.

The first electrode 150 and the second electrode 160 may include a transparent conductive material such as ITO, IZO, and AZO, which are polycrystalline, monocrystalline or amorphous.

The second electrode 160 has a stripe pattern including a plurality of branch electrodes 161. In order to form the second electrode 160, a second electrode-forming material is first coated on the entire insulating layer 147, and thereafter the second electrode-forming material is selectively removed from an area overlapping the first electrode 150, so that a plurality of cutout portions 169 are formed, and as a result a plurality of branch electrodes 161 are formed.

FIG. 9 illustrates an in-plane switching mode LCD device in which the first and second electrodes 150 and 160 are disposed on the first substrate 110 and within the lower plate 100. In an LCD device in which an electric field is applied in a direction perpendicular to a substrate as in VA and TN modes, the second electrode 160 may be disposed on the second substrate 210.

Referring to FIGS. 9 and 10H, the color filter 220 and the black matrix 230 are formed on the second substrate 210, and the insulating layer 240 is formed on the color filter 220 and the black matrix 230.

In detail, the color filter 220, and the black matrix 230 which is a light-shielding member, are formed on the second substrate 210 including transparent glass or plastic.

The insulating layer 240 is disposed on the color filter 220 and the black matrix 230, and the upper plate second electrode conductive line 163 is formed on the black matrix 230. The upper plate second electrode conductive line 163 may be formed by using TCO, and may include a branch electrode as in illustrated for the second electrode 160 of the lower plate 100. The upper plate second electrode conductive line 163 on the black matrix 230 may include a metal.

FIGS. 9 and 10H illustrate the black matrix 230 and the color filter 220 both disposed on the second substrate 210, but the black matrix 230 may be disposed on the first substrate 110, and the color filter 220 may also be disposed on the first substrate 110.

A conductive spacer may be formed on the first substrate 110 or the second substrate 210.

In other words, the conductive spacer may be formed on the lower plate 100 in which the first substrate 110 is disposed, or may be formed on the upper plate 200 in which the second substrate 210 is disposed. FIG. 10G shows the conductive spacer formed on the lower plate 100. However, the conductive spacer may also be formed on the upper plate 200 unlike FIG. 10G.

Referring to FIGS. 10G and 10H, the conductive spacer may be formed on an upper part 165b of the TFT in the display area and corresponding to the black matrix 230, and may be formed in the non-display area NDA. The LCD display may include a plurality of spacers, of which a conductive display area DA spacer 172 and a conductive non-display area NDA spacer 175 are formed, such as in a same layer and/or including the same material.

A forming of the conductive spacer may include, for example, coating a spacer-forming polymer composition on the first substrate 110 or the second substrate 210, forming a polymer resin by selectively polymerizing and curing the coated polymer composition, and patterning the polymer resin.

The polymer composition may be a photo-polymerizable polymer composition including photo-polymerizable initiator, photo-polymerizable monomer, photo-polymerizable oligomer and conductive filler. The polymer composition may have viscosity so as to limit flowability thereof when coated on the first substrate 110 or the second substrate 210.

In the selectively curing the polymer resin, light irradiation occurs and a pattern mask having light transmission varying depending on locations may be used.

In an exemplary embodiment, for example, the pattern mask may include a light transmission portion having high transmittance at an area where a polymer resin may remain to form a spacer, and a light blocking portion having relatively low transmittance at an area from which the polymer resin may be removed. The light transmittance may vary depending on locations in the light transmission portion of the pattern mask. For instance, the light transmittance varies depending on locations in the light transmission portion, so that polymerization and curing time of the polymer composition may also vary depending on locations when light irradiation occurs. Accordingly, a part of a conductive filler of an area having short polymerization and curing time moves to an area having long polymerization and curing time, and thus the conductive filler of the area having long polymerization and curing time may have a relatively high density. As a result, a conductive network continuously extending from an upper portion of a polymer resin to a lower portion thereof may be easily formed in the above area.

Next, referring again to FIG. 10H, the liquid crystal 310 is interposed between the first substrate 110 and the second substrate 210, with the conductive spacer interposed therebetween, and the first substrate 110 and the second substrate 210 are bonded to each other, thereby forming the liquid crystal layer 300 (see FIG. 10H).

From the foregoing, it will be appreciated that various exemplary embodiments of the invention have been described herein for purposes of illustration, and that various modifications may be made without departing from the scope and spirit of the invention. Accordingly, the various embodiments disclosed herein are not intended to be limiting, with the true scope and spirit being indicated by the following claims, and equivalents thereof.

What is claimed is:

1. A liquid crystal display device comprising:
a first substrate;
a thin film transistor on the first substrate;
a first electrode on the first substrate and connected to the thin film transistor;
a second substrate facing the first substrate;
color filters on the first substrate or the second substrate;
a black matrix between the color filters on the first substrate or the second substrate;
a second electrode spaced apart from the first electrode and on the first substrate or the second substrate;
a second electrode conductive line, on the black matrix;
a spacer between the first substrate and the second substrate, and configured to support the first substrate and the second substrate; and
a liquid crystal layer between the first substrate and the second substrate,
wherein the spacer is electrically connected to the second electrode and the second electrode conductive line.

2. The liquid crystal display device of claim 1, wherein the spacer comprises a conductive polymer.

3. The liquid crystal display device of claim 2, wherein the conductive polymer comprises at least one selected from polyacetylene, polythiophene, poly(3-alkylthiophene), polypyrrole, poly(isothianaphthene), poly(ethylenedioxythiophene), alkoxy-substituted poly(para-phenylene vinylene), poly(para-phenylene vinylene), poly(2,5-dialkoxy-para-phenylene vinylene), poly(para-phenylene), ladder-type poly(para-phenylene), poly(para-phenylene sulphide), polyheptadiyne, poly(3-hexylthiophene) and polyaniline.

4. The liquid crystal display device of claim 1, wherein the spacer comprises polymer resin, and conductive filler dispersed in the polymer resin.

5. The liquid crystal display device of claim 4, wherein the polymer resin comprises at least one selected from conductive polymer and photo-polymerized polymer.

6. The liquid crystal display device of claim 4, wherein the conductive filler comprises at least one selected from a metal particle, a metal particle coated with a metal, a non-metal particle coated with a metal, a conductive non-metal particle, a metal particle coated with conductive non-metal, and conductive polymer.

7. The liquid crystal display device of claim 4, wherein the spacer has a compression stability of about 70% or more.

8. The liquid crystal display device of claim 4, wherein the spacer has a sheet resistance of about 150 ohms per square or less.

9. The liquid crystal display device of claim 1, wherein
the first substrate comprises a display area where an image is displayed, and a non-display area where an image is not displayed,
the non-display area of the first substrate comprises a common voltage supply line, and
the common voltage supply line is electrically connected to the second electrode conductive line, via the spacer.

10. The liquid crystal display device of claim 1, wherein the second electrode is spaced apart from the first electrode and disposed on the first substrate.

11. The liquid crystal display device of claim 1, wherein the first electrode overlaps the second electrode in an area corresponding to the color filters, further comprising an insulating layer between the overlapping first and second electrodes in the area corresponding to the color filters.

12. The liquid crystal display device of claim 1, wherein the first electrode or the second electrode comprises a plurality of branch electrodes.

13. The liquid crystal display device of claim 1, wherein the black matrix is on the second substrate.

14. A method of manufacturing a liquid crystal display device, the method comprising:
forming a thin film transistor, and a first electrode connected to the thin film transistor, on a first substrate;
forming color filters on the first substrate or a second substrate;
forming a black matrix on the first substrate or the second substrate, and between the color filters;
forming a second electrode on the first substrate or the second substrate, to be spaced apart from the first electrode;
forming a second electrode conductive line on the black matrix;
forming a spacer on the first substrate or the second substrate;
providing a liquid crystal layer between the first substrate and the second substrate; and
coupling the first substrate and the second substrate to each other with the spacer therebetween,
wherein the forming the spacer comprises:
coating a spacer-forming polymer composition on the first substrate and the second substrate, to form a polymer resin; and
patterning the polymer resin formed by the polymer composition, and wherein in the coupling the first substrate and the second substrate to each other, the spacer is electrically connected to the second electrode and the second electrode conductive line.

15. The method of claim 14, wherein the polymer composition comprises photo-polymerizable initiator, photo-polymerizable monomer, photo-polymerizable oligomer and conductive filler.

16. The liquid crystal display device of claim 1, wherein
the liquid crystal display device comprises a display area where an image is displayed, and a non-display area where an image is not displayed;
the second electrode is in the display area; and
the second electrode conductive line is in the non-display area.

17. The liquid crystal display device of claim 16, further comprising a plurality of second electrode conductive lines,
wherein
an upper second electrode conductive line is on the second substrate, and in the display area and the non-display area, and
a lower second electrode conductive line is on the first substrate and in the non-display area.

18. The liquid crystal display device of claim 17, further comprising a plurality of spacers,
wherein
a first spacer is in the display area and electrically connects the second electrode and the upper second electrode conductive line, and
a second spacer is in the non-display area and electrically connects the upper and lower second electrode conductive lines to each other.
